(19) United States
(12) Patent Application Publication
(10) Pub. No.: US 2003/0176819 A1
(43) Pub. Date: Sep. 18, 2003

(54) Device and method for massaging genitals

(76) Inventor: Ee Do Kim, Kyungki-Do (KR)

Correspondence Address: BIRCH STEWART KOLASCH & BIRCH, PO BOX 747, FALLS CHURCH, VA, 22040-0747, US

(21) Appl. No.: 10/385,682

(22) Filed: Mar. 12, 2003

(30) Foreign Application Priority Data
Mar. 15, 2002 (KR) 2002-14148

(51) Int. Cl. A61H 19/00

(52) U.S. Cl. 601/98; 601/101; 601/136

(57) ABSTRACT

A device and method are provided for massaging a body area of a user, such as a sphincter muscle of the user. The device includes a basic plate, an upper plate supported the basic plate, and a massaging member mounted on the upper plate. The massaging member includes an opening disposed in the massaging member, a massaging plate disposed within the opening for providing space to move the massaging plate within the opening in a reciprocating manner, and a mechanism for movably engaging the massaging plate with the upper plate. When the massaging plate is moved in the reciprocating manner after the user sits on a portion of the massaging plate, the body area of the user is massaged by the massaging plate.

The present application claims the priority benefit, under 35 U.S.C. §119, of Korean Patent Application No. 2002-14148 filed on Mar. 15, 2002, the entire contents of which are herein fully incorporated by reference.

### BACKGROUND OF THE INVENTION

1. Field of the Invention

The present invention relates to a device and method for massaging male genitals and more particularly, to an improved device and method for massaging and training sphincter located around a male genital of a human body, for gradually and effectively improving and revitalizing sexual functions of the genital.

2. Description of the Related Art

Various types of devices and methods for massaging male genitals may be known. Generally, when a male gets cold, his sphincter muscle may become constricted and weak. This may cause urinary diseases, premature ejaculations, fistulas, constipation, decline in energy including sexual energy, etc. The sphincter muscle is located around a male genital and anus for shrinking and stretching the muscles around the genital and anus.

Accordingly, to train and strengthen the sphincter muscle, Kegel exercise programs have been developed. Kegel exercise program is a kind of physical exercise and gymnastics for strengthening the sphincter muscle. However, such a conventional Kegel exercise program does not provide a good result in reality.

Also, Korean Utility Model Patent No. 20-234,956 discloses an exercise supplementary device which includes an outer tube, an inner tube moveably inserted into the outer tube, and an elastic rubber ring attached to a circumference of the outer tube and attached to the glands of the penis whereby when the inner tube moves up and down, the sphincter muscle of the male genital can be made to shrink and stretch out. However, such a device can give a harmful result to the personal. Further, the method of using this device is inconvenient as well as uncomfortable to a user.

### SUMMARY OF THE INVENTION

Therefore, an object of the present invention is to provide a device and method for massaging a genital of a person, which eliminates the problems and limitations associated with the conventional art.

Another object of the present invention is to provide an improved device and method for massaging the sphincter muscle located near a male genital and anus, for comfortably and effectively improving and revitalizing the sexual functions of the genital.

Still another object of the present invention is to provide a device for massaging male genitals which is simple in structure, inexpensive to manufacture, durable in use, and refined in appearance.

In accordance with an embodiment of the present invention, a device for massaging a body area of a user, comprising: a basic plate; an upper plate supported the basic plate; a massaging member mounted on the upper plate, the massaging member including an opening disposed in the massaging member, a massaging plate disposed within the opening, for providing space to move the massaging plate within the opening in a reciprocating manner, and a mechanism for movably engaging the massaging plate with the upper plate; and a mechanism for operating the massaging plate, whereby when the massaging plate is moved in the reciprocating manner after the user sits on a portion of the massaging plate, the body area of the user is massaged by the massaging plate.

In accordance with an embodiment of the present invention, a method of massaging a body area of a user, the method comprising: sitting on a portion of a massaging member supported on an upper plate, the massaging member including a massaging plate and an opening to move the massaging plate within the opening; gripping a handle supported on the upper plate; actuating a motor disposed on a basic plate; moving the massaging plate within the opening in a reciprocating manner, based on the actuation of the motor; and massaging the body area of the user by the movement of the massaging plate.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a perspective view of a device for massaging a genital area of a user according to an embodiment of the present invention;

FIG. 2 is a sectional view of FIG. 1;

FIG. 3 is an enlarged perspective view of a massaging member of the device of FIG. 1 according to an embodiment of the present invention;

FIG. 4 is a cross-sectional view of FIG. 1; and

FIG. 5 is a bottom plan view of the massaging member shown in FIG. 3 according to an embodiment of the present invention.

### DETAILED DESCRIPTION OF THE PREFERRED EMBODIMENTS

Referring now in detail to the drawings for the purpose of illustrating preferred embodiments of the present invention, a device 1 for massaging genitals (or genital areas) according to an embodiment of the present invention as shown in FIGS. 1, 2 and 4, includes: an upper plate 2, a massaging member 6 disposed on the upper plate 2, a basic plate 3 for supporting the upper plate 2 thereon at a slant angle through a plurality of supports 17, and a motor 4 mounted on the basic plate 3 and operatively connected to the massaging member 6. The device 1 also includes an ON/OFF switch (not shown) for turning on/off the device 1. The ON switch would allow the motor 4 to actuate, whereas the OFF switch will turn off the motor 4. All the elements of the device 1 are operatively coupled. The upper plate 6 is disposed at a slant slope with respect to the basic plate 3 for a user to stably sit thereon.

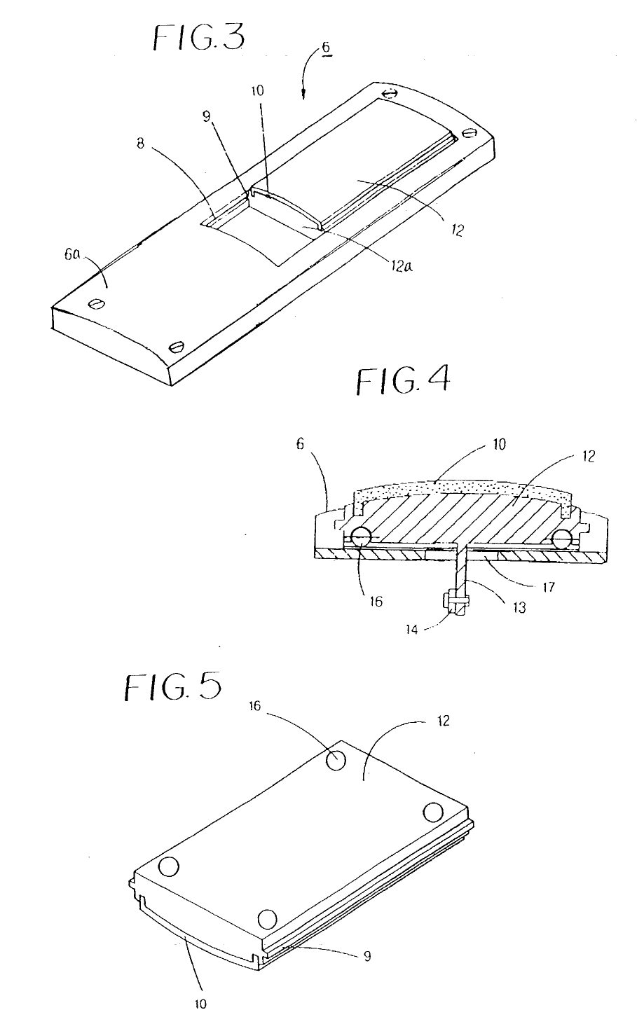

As shown in FIGS. 3, 4, and 5, the massaging member 6 having a curved or rounded top surface, includes an opening 7 (e.g., in the rectangular shape) disposed in the center or a predetermined location of the massaging member 6; a sitting area 6a on which a user sits; a massaging plate 12 disposed within the opening 7 and having a pair of raised portions 9 extending on the outer opposites sides of the massaging plate 12, respectively; a pair of guide grooves 8 provided respectively on the inner opposite sides of the massaging plate and receiving therein the pair of raised portions 9, respectively, to slide the raised portions 9 therealong; and a connecting plate 13 extended from the bottom of the massaging plate 12. The connecting plate 13 can be provided integrally or adhesively to the bottom surface of the massaging plate 12.

In the present example, the massaging plate 12 has a length smaller than the length of the opening 7 so as to provide a room for the massaging plate 12 to move in a reciprocating manner within the opening 7 by the operation of the raised portions 9 and the grooves 8. In one example, the massaging plate 12 has a curved top surface and a massaging over 10 adhered on the curved top surface for smoothly accelerating or decelerating the reciprocating movement speed of the massaging plate 12. Further, an additional cover or cushion may be provided at a face area 12a of the massaging plate 12. The face area 12a is an area where the user's genital area comes into contact with. The massaging cover 10 and the cushion at the face area 12a may be a sponge, a cloth, or the like. Each of the raised portions 9 can have a width selected from a range of, e.g., approximately 1-5 mm.

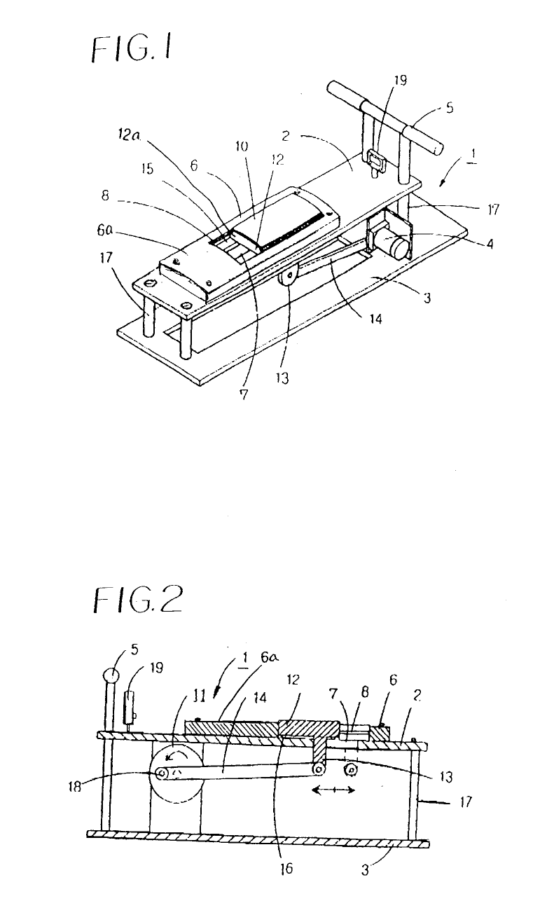

Referring in detail to FIGS. 1 and 2, the motor 4 mounted on the basic plate 3 is coaxially connected to an eccentrical cam 11. Since the cam 11 is connected to the massaging plate 12 through a connecting rod 14 and the connecting plate 13, upon the rotation of the motor 4 the massaging plate 12 is moved in reciprocation motion in the lengthwise direction (FIG. 2). At this time, as shown in FIG. 2, the cam 11 can eccentrically rotate in the direction indicated by an arrow due to an eccentrical cam shaft 18 of the cam 11. If necessary, the user can replace the cam 11 with a conventional crank or any other suitable mechanism that provide a reciprocating motion. In other example, the motor 4 can be substituted with a conventional gear-motor, a transmission or the like, having a means to control the speed thereof.

A handle 5 is located at a higher end portion of the upper plate 2 compared with the other elements of the upper plate 2. The handle 5 is supported on the basic plate 3, so as to allow the user to grip the handle 5 before, during or after the use of the device 1. The handle 5 provides support and stability to the user during the massaging operation of the device 1. A timer 19 is disposed on the upper plate 2, e.g., in the vicinity of the handle 5 or anywhere the user can see. The timer 19 is a conventional time and can have a conventional electric power on/off switch, an overload cut switch, and miscellaneous control switches.

Referring in detail to FIGS. 4 and 5, in order to accelerate the gentle movement of the massaging plate 12, a plurality of bearings 16 are aligned in the opposite lengthwise sides of the bottom thereof. The bearings 16 will allow the massaging plate 12 to reciprocate more smoothly and gently which provide a more smooth and gentle touching of the sphincter muscle of the user. In this example, the bearings 16 are disposed at four corners of the massaging plate 12, but a different number of bearings 16 may be used as needed.

Referring to FIGS. 1 and 2, the device 1 operates as follows. The device 1 is maintained at an OFF stage in its initial position. After the user sits on the sifting area 6a of the massaging member 6 and grips the handle 5, the user can turn on the ON switch to activate the device 1 into the ON state. Then the motor 4 is actuated which in turn causes the massaging plate 12 to start to move forward and backward repeated in the reciprocating manner. By the reciprocating movement of the massaging plate 12 which gently contacts or massages the sphincter muscle (or a genital area generally) of the user, the sphincter muscle of the muscle can be trained, strengthened and energized, whereby the ability of the sphincter muscle (or genital) to perform sexual or other functions are improved or revitalized.

In the above operation, since the motor 4 has a coaxial shaft with the eccentrical cam shaft 18 in the cam 11, according to the rotation of the cam 11, the rotation motion of the cam 11 is transferred to the reciprocation motion of the massaging plate 12 through the connecting rod 14 and the connecting plate 13. The massaging plate 12 is moved smoothly within the opening 7 of the plate 6 according to the operation of the raised portions 9 smoothly engaging with the guide grooves 8 with the support of the bearings 16 and the cover 10.

For example, after opening both legs, the user (e.g., an old aged man) can sit on the sitting area 6a of the massaging member 6 of the present device 1, sets the timer 19 for a desired massaging time duration (e.g., 5 to 10 minutes), and grips the handle 5. Then the device 1 (i.e., the motor 4) will be actuated. At this time, the device 1 may be configured to actuate the motor 4 automatically (e.g., after a certain time duration has passed) or manually in response to the manual actuation of the ON/OFF switch of the device. When the electric ON/OF switch is turned on the motor 4 begins to operate, the cam 11 is actuated causing the massaging plate 12 to move in the reciprocating motion repeatedly as discussed above. At this time, the user usually concentrates one's weight, e.g., about 55 kg to 85 kg, to the massaging plate 12. Occasionally, the weight of the user can be lifted slightly from the massaging plate 12 for controlling friction between the massaging cover 10 and the sphincter muscle of the user.

Although the use of the device 1 has been discussed to massage a genital area of a male, the present invention is not limited to such and is equally applicable, if desired, to the use of the device 1 to massage a genital area or other area of a male, a female, or any entity in needed of a massage.

Accordingly, the present invention provides a device and method of massaging a genital area (e.g., the sphincter muscle) of a user. By the use of the present invention, the user's sexual capacity/capability may be revitalized and improved significantly, and diseases such as urinary, premature ejaculation, anal fistulas, constipation, fatness and decline of energy can be prevented.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A device for massaging a body area of a user, the device comprising:
a basic plate;
an upper plate supported the basic plate;
a massaging member mounted on the upper plate, the massaging member including,
an opening disposed in the massaging member,
a massaging plate disposed within the opening, for providing space to move the massaging plate within the opening in a reciprocating manner, and
means for movably engaging the massaging plate with the upper plate; and
means for operating the massaging plate,
whereby when the massaging plate is moved in the reciprocating manner after the user sits on a portion of the massaging plate, the body area of the user is massaged by the massaging plate.

2. The device of claim 1, wherein the body area of the user is a genital area of the user.

3. The device of claim 2, wherein the genital area of the user includes a sphincter muscle of the user.

4. The device of claim 1, wherein the upper plate is supported on the basic plate at a slant angle.

5. The device of claim 1, wherein the engaging means includes:
a pair of raised portions extending from outer opposite sides of the massaging plate, respectively; and
a pair of guide grooves extending from inner opposite sides of the massaging plate, respectively, and slidably receiving the raised portions therein respectively.

6. The device of claim 5, wherein each of the raised portions has a length of approximately 1 mm to 5 mm.

7. The device of claim 1, wherein the operating means includes:
a motor secured on the basic plate;
an eccentrical cam having a coaxial shaft with the motor;
a connecting plate extending from a bottom area of the upper plate; and
a connecting rod connected to the cam shaft and the connecting plate,
whereby upon operating the motor, the massaging plate is moved in the reciprocating manner due to the eccentrical cam.

8. The device of claim 1, further comprising:
a plurality of supports to support the upper plate on the basic plate at a slant angle.

9. The device of claim 8, wherein the supports include four supports located on four corner areas of the basic plate.

10. The device of claim 1, wherein each of the massaging member and the massaging plate have a curved top surface.

11. The device of claim 10, wherein the massaging plate includes a massaging cover on a top surface thereof for reducing friction between the massaging plate and the body area of the user.

12. The device of claim 1, wherein the massaging plate includes a cushion on a face of the massaging plate, to gently massage the body area of the user.

13. The device of claim 1, wherein the massaging plate includes a plurality of bearings disposed on a bottom area of the massaging plate.

14. The device of claim 13, wherein the bearing include four bearings located on four corner areas of the massaging plate.

15. The device of claim 1, further comprising:
a handle disposed on the upper plate; and
a timer disposed in the vicinity of the handle.

16. A method of massaging a body area of a user, the method comprising:
sitting on a portion of a massaging member supported on an upper plate, the massaging member including a massaging plate and an opening to move the massaging plate within the opening;
gripping a handle supported on the upper plate;
actuating a motor disposed on a basic plate;
moving the massaging plate within the opening in a reciprocating manner, based on the actuation of the motor; and
massaging the body area of the user by the movement of the massaging plate.

17. The method of claim 16, wherein the body area of the user is a genital area of the user, the genital area including a sphincter muscle of the user.

18. The method of claim 16, further comprising:
setting a timer after the gripping step to carry out the massaging step for a predetermined time duration.

19. The method of claim 16, wherein the motor is actuated automatically or manually after the gripping step or after the sitting step.
